(19) United States
(12) Patent Application Publication
(10) Pub. No.: US 2008/0259794 A1
(43) Pub. Date: Oct. 23, 2008

(54) Apparatus And Method For Providing End-To-End QoS Guarantee Within Service Network

(75) Inventors: Xianjun Zou, Shenzhen (CN); Yan Li, Shenzhen (CN); Xiaomin Shi, Shenzhen (CN)

Correspondence Address: HARNESS, DICKEY & PIERCE, P.L.C., P.O. BOX 828, BLOOMFIELD HILLS, MI, 48303, US

(73) Assignee: HUAWEI TECHNOLOGIES CO., LTD.

(21) Appl. No.: 12/140,698

(22) Filed: Jun. 17, 2008

Related U.S. Application Data
(63) Continuation of application No. PCT/CN2007/000202, filed on Jan. 18, 2007.

(30) Foreign Application Priority Data
May 30, 2006 (CN) CN200610083218.3

(51) Int. Cl. H04L 12/26

(52) U.S. Cl. 370/231; 370/252

(57) ABSTRACT

The present disclosure provides an apparatus and a method for providing end-to-end Quality of Service (QoS) guarantee within the service network. The apparatus is implemented by a Service Resource Monitor/Manager (SRM), and includes a service processing unit and a resource management unit. The method includes: configuring an SRM within the service network, monitoring and managing, by the SRM, resource utilization of application servers within the service network; after receiving a service request of a subscriber service, generating, by the SRM, a processing plan for the subscriber service according to the obtained information about resource utilization of the application servers within the service network and QoS requirement required by the subscriber service which is carried in the service request, and delivering the specific processing plan to a sender of the service request.

### CROSS-REFERENCE TO RELATED APPLICATIONS

This application is a continuation of International Application No. PCT/CN2007/000202, filed Jan. 18, 2007. This application claims the benefit of Chinese Application No. 200610083218.3, filed May 30, 2006. The disclosures of the above applications are incorporated herein by reference.

### FIELD

The present disclosure relates to the field of network communication, and more particularly, to an apparatus and a method for providing end-to-end Quality of Service (QoS) guarantee within a service network.

### BACKGROUND

The statements in this section merely provide background information related to the present disclosure and may not constitute prior art.

With the development of telecommunication network technology and subscriber demand, various uni-service network operators are turning to integrated information providers. Uni-service network operators mainly provide traditional voice service to subscribers, and integrated information providers mainly provide rich multimedia services and data services to subscribers, for example, provide multimedia message service (MMS), news, video phone, interactive message, game, music, entertainment, location service etc., to subscribers. These multimedia services and data services have attracted more subscribers, and have brought operators more network service traffic and business income, meanwhile these rich multimedia services and data services have constituted a new overlay network, namely service network.

With the continuous emerging of various rich multimedia services and data services and the continuous increasing of various subscriber demands, the future telecommunication network will be centered on subscribers, mainly to meet various performance requirement of subscribers on the services, and take into account the subscribers' satisfaction and loyalty to the network operators.

Compared with traditional telecommunication service such as voice service, the types and complexity of the multimedia service and data service increase, and the multimedia service and data service have more complicated service logic. It might need the coordination of multiple service servers within the service network to accomplish a subscriber service. For example, the currently hot composite service, service chain etc., all need the coordination of multiple application servers within the service network to meet subscriber demands.

How to guarantee that subscribers can still achieve good service experience in the above situation is an issue required to be solved by the network operators.

In the prior art, a method of providing QoS guarantee for subscriber service within a service network is a solution employing a network admission system. The architecture of the solution is shown in FIG. 1. In the solution, one or more Network Admission Controls (NAC) are deployed at edge nodes and one or more Network Control Servers (NCS) are deployed in a core network. Whether to permit requested data flow to pass through the current network or not are determined according to resource utilization, load ratio, QoS guarantee needed by the requested data flow in the current network. The method is mainly used to avoid resource bottleneck and guarantee data transmission with QoS requirement.

The above method in the prior art has the following defects:

1. The method aims at a single type of application server, and all the monitored resources are unified homogeneous resources. But resources contained in various heterogeneous application servers are different from each other, and the method can not provide resource monitoring and admission control for various different heterogeneous application servers simultaneously. Therefore, the method does not have scalability and can not be applied to the whole service network.

2. The method can not choose and detect required application servers according to the characteristic of requested data flow.

### SUMMARY

An object of an embodiment of the present disclosure is to provide an apparatus and a method for providing end-to-end QoS guarantee within a service network, so as to guarantee end-to-end service QoS within the service network and improve utilization efficiency of application servers within the service network.

The object of the embodiment of the present disclosure is achieved by the following technical solution:

An apparatus for providing end-to-end QoS guarantee within a service network includes a Service Resource Monitor/Manager (SRM), and the SRM includes a resource management unit and a service processing unit.

The resource management unit is adapted to monitor and manage resource utilization of application servers within the service network; return information about resource utilization of corresponding application servers according to a query request sent by the service processing unit.

The service processing unit is adapted to send the query request to the resource management unit according to information about QoS requirement required by the subscriber service which is carried in a received service request, receive the information about resource utilization of the corresponding application servers, generate a processing plan for the subscriber service according to the information about QoS requirement and the information about resource utilization, and deliver the specific processing plan to a sender of the service request.

A method is to provide the end-to-end QoS guarantee within a service network, an SRM being configured in the service network. The method particularly includes: monitoring and managing, by the SRM, resource utilization of application servers within the service network; after receiving a service request of a subscriber service, generating, by the SRM, a processing plan for the subscriber service according to the obtained information about resource utilization of the application servers within the service network and QoS requirement required by the subscriber service which is carried in the service request, and delivering the specific processing plan to a sender of the service request.

It can be seen from the technical solution according to the embodiment of the present disclosure, by deploying an SRM in a service network, the SRM may dynamically monitor resource utilization of application servers within the service network and dynamically generate a specific service processing plan; the present disclosure may guarantee end-to-end service QoS within the service network, improve utilization efficiency of application servers within the service network, assure subscribers' service use and experience to the maximum extent, and optimize resource utilization efficiency within the whole service network. The present disclosure solves the problems in the prior art that heterogeneous QoS guarantee can not be carried out according to the characteristic of the service and required application servers can not be chosen and detected dynamically.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram illustrating the architecture of a solution employing a network admission system in the prior art;

FIG. 2 is a schematic diagram illustrating the architecture of a network when SRMs are deployed in a distributed manner; and

FIG. 3 is a schematic diagram illustrating the functional architecture of an SRM according to an embodiment of the present disclosure.

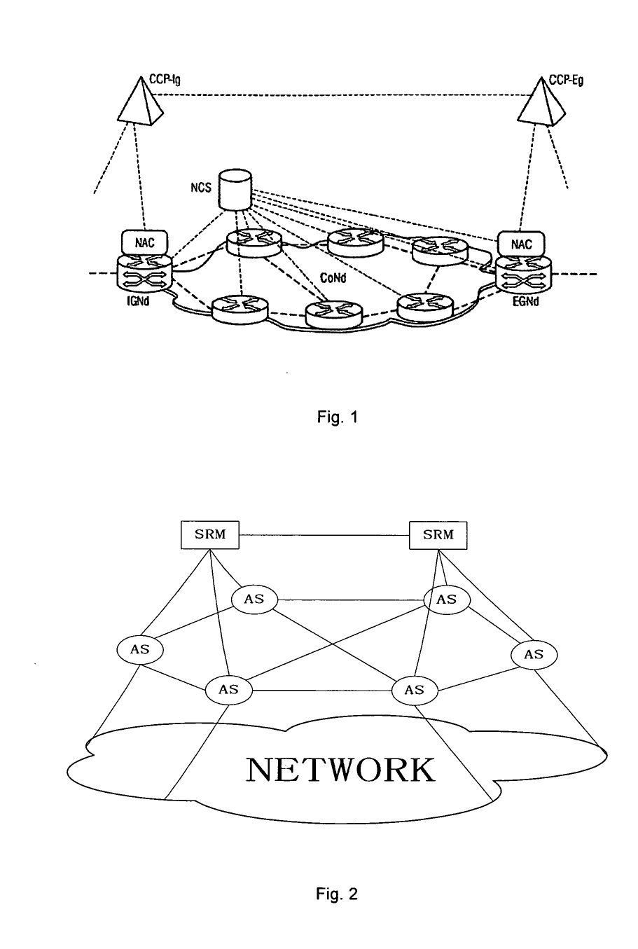

### DETAILED DESCRIPTION

The following description is merely exemplary in nature and is not intended to limit the present disclosure, application, or uses.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

An embodiment of the present disclosure provides an apparatus and a method providing end-to-end QoS guarantee within a service network. The main technical characteristics of the embodiment of the present disclosure are as follows: an SRM is provided within the service network; the SRM dynamically monitors resource utilization of application servers within the service network, and generates a specific service processing plan according to the obtained resource utilization, control policy and QoS requirement of subscriber service.

The apparatus of the present disclosure will be discussed in detail below in conjunction with the figures. The apparatus according to the embodiment of the present disclosure is implemented by an SRM.

As a resource management apparatus, the SRM dynamically monitors and manages resource utilization of application servers within the service network. The resource utilization includes information about QoS parameters of application servers, transmission delay among application servers, media resources provided by application servers etc. The information about QoS parameters includes load ratio, response time, bandwidth, code rate, display resolution etc., of application servers. QoS parameters corresponding to each kind of application server are different, some might be load ratio and bandwidth, some might be code rate and display resolution, and some might be bandwidth and display resolution.

The SRM generates a processing plan for the subscriber service according to the information about QoS parameters required by the subscriber service through the application servers, the obtained information about resource utilization of the application servers, and preset information about control policy, and delivers the processing plan to the application servers.

The SRM may be deployed in the service network in a centralized manner, a distributed manner or a mixed manner. When deployed in a centralized manner, one SRM needs to monitor and manage resource utilization of all the application servers within the whole service network. When deployed in a distributed manner or a mixed manner, it might need multiple SRMs to monitor and manage resource utilization of all the application servers within the service network, each SRM might monitor resource utilization of one or more application servers, and there are communication interfaces between SRMs. When SRMs are deployed in a distributed manner, the architecture of the service network is shown in FIG. 2. In FIG. 2, AS is an application server.

As shown in FIG. 2, the lowest layer of the architecture of the service network is a fundamental network layer, which is used to assure the communication between application servers, between application server and SRM, and between SRMs. The fundamental network layer may include multiple routers and physical links, which are used to process specific subscriber service and provide application service for the subscriber service. The service network is above the fundamental network layer, and in the service network it might need the coordination among multiple application servers to process a service request of one subscriber service.

The relationship between SRM and application server may be one-to-one or one-to-many. SRMs need to communicate with each other, so as to provide end-to-end QoS guarantee within the whole service network.

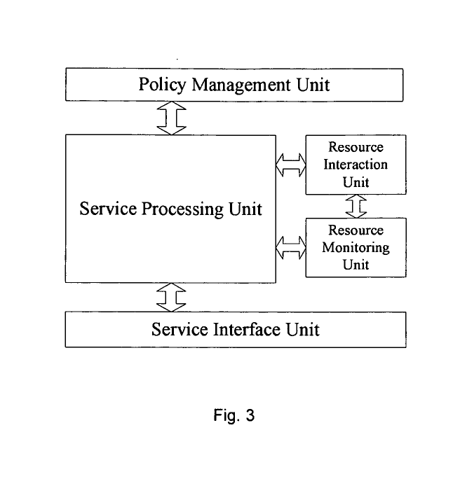

As shown in FIG. 3, the function architecture of the SRM includes a service interface unit, a resource monitoring unit, a resource interaction unit, a service processing unit, a policy management unit etc.

The function of each module in the SRM is described as follows:

1) The service interface unit provides query and response interfaces for a subscriber service, receives a service request of the subscriber service using the query interface, the service request being sent through an application server, and delivers the received service request to the service processing unit. The service request includes QoS parameter value, QoS parameter name and relevant requirement required by the subscriber service, and the identifiers and the number of required application servers. The QoS parameter requirement includes but is not limited to response time for the whole service, required bandwidth, etc. Through the response interface, the service interface unit also delivers a specific processing plan that the service processing unit has generated for the subscriber service to the application server that has sent the service request. The specific processing plan includes information about a list of application servers that provide service for the subscriber service and addresses of the application servers, or information about denial of the service request of the subscriber service.

2) The resource monitoring unit monitors and manages resource utilization of managed application servers. The resource monitoring unit may initiatively query resource utilization of the relevant application servers. Alternatively, each application server may initiatively report the current resource utilization to the resource monitoring unit. The resource monitoring unit saves the obtained information about resource utilization of the application servers, and delivers the information to the service processing unit. A resource status list may be maintained in the resource monitoring unit, the resource status list includes: ID of application server, address of application server and various QoS parameters provided by the application server. These QoS parameters include but are not limited to: the current response time, the current load ratio, the current available bandwidth of the application server, etc. Because the QoS parameters that each kind of application server involves are different, it is quite difficult to perform unified modeling by means of database, so the resource status list is stored in the resource monitoring unit in the format of Extensible Markup Language (XML). And parameters of available resources of the relevant application servers are modified according to a policy delivered from the service processing unit.

The format of the XML file used to describe the resource status list may be as follows:

```
    <AppQoS xmlns=“http://huawei.com/appqos.xsd”>
      <service name=“movieserver” address=“127.0.0.1” >
        <Parameter name=“bandwidth” mode=“equal”
unit=“Mbps” needTransfer=“TRUE”>
          <value>60</value>
            <value>40</value>
            </Parameter>
        <Parameter name=“responsetime” mode=“less”
unit=“ms” needTransfer=“FALSE” >
          <value>40</value>
        </Parameter>
        <Parameter name=“bitrate” mode=“equal”
unit=“Mbps” needTransfer=“TRUE”>
          <value>10</value>
        </Parameter>
      </service>
    </AppQoS>
```

A Schema corresponding to the XML file is as follows:

```
<xsd:Schema targetNamespace=“http://huawei.com/appqos.xsd”
        xmlns:xsd=“http://www.w3.org/1999/XMLSchema”>
    <xsd:element name=“AppQoS”>
      <xsd:complexType>
          <xsd:sequence>
                <xsd:element name=“service” minOccurs=“0”
maxOccurs=“unbounded”>
      <xsd:complexType>
        <xsd:sequence>
            <xsd:element name=“Parameter” minOccurs=“0”
maxOccurs=“unbounded”>
                <xsd:complexType>
                  <xsd:sequence>
                    <xsd:element name=“value” type=“xsd:int”
minOccurs=“1” maxOccurs=“unbounded”>
                  <xsd:sequence>
                  <xsd:attribute name=“mode” type=“modeType”
minOccurs=“0”/>
                  <xsd:attribute name=“unit” type=“unitType”
minOccurs=“0”/>
                  <xsd:attribute name=“needTransfer”
type=“Boolean” minOccurs=“0”/>
                </xsd:complexType>
            </xsd:element>
        </xsd:sequence>
              <xsd:attribute name=“address” type=“xsd:string” />
        <xsd:attribute name=”name” type=”xsd:string”/>
            </xsd:complexType>
                  </xsd:element>
                </sequence>
            </xsd:complexType>
      </xsd:element>
      <xsd:simpleType name=“modeType”>
          <xsd:restriction base=“xsd:string”>
              <xsd:enumeration value=“less”/>
              <xsd:enumeration value=“more”/>
              <xsd:enumeration value=“equal”/>
          </xsd:restriction>
      </xsd:simpleType>
      <xsd:simpleType name=“unitType”>
          <xsd:restriction base=“xsd:string”>
              <xsd:enumeration value=“ms”/>
              <xsd:enumeration value=“Mbps”/>
              <xsd:enumeration value=“Kbps”/>
              <xsd:enumeration value=“s”>
          </xsd:restriction>
      </xsd:simpleType>
</xsd:Schema>
```

Annotation for the Schema: the Schema may describe information about application QoS corresponding to a service itself, and also may describe information about service and QoS required in a service request. In the XML file, the element ‘service’ represents the actual service, and the attribute ‘name’ of the actual service represents the name of the service and ‘address’ indicates the current address of the service (the attribute is optional in the service request description). ‘Parameter’ is used to describe information about QoS parameters corresponding to the service; the attribute ‘name’ indicates the name of the parameter; and ‘mode’ represents a mode. In the QoS description of the service itself; the attribute ‘mode’ is used to describe QoS guarantee that the application server can provide; ‘less’ indicates that the QoS value provided by the application server is less than the value in the sub element ‘value’; ‘equal’ indicates that the QoS value provided by the application server is equal to the value in the sub element ‘value’; if there are multiple ‘value’s, this indicates that the service may provide multiple levels of service; ‘more’ indicates the QoS value is greater than the value in the sub element ‘value’. In the service request, the attribute ‘mode’ is used to describe QoS characteristic required by the service request. It should be noted that for the attribute ‘mode’, ‘less’ indicates that the required QoS is less than the value in the sub element ‘value’, ‘equal’ indicates that the required QoS is equal to the value in the sub element ‘value’, and ‘more’ indicates that the required QoS is greater than the value in the sub element ‘value’.

3) The resource interaction unit provides an interaction interface between SRMs. An SRM may send a resource query request to another SRM through the interaction interface to obtain resource utilization of application servers managed by the other SRM. The resource query request sent to the other SRM includes application server types, QoS parameters required by the subscriber service, etc.

An SRM may also receive a resource query request sent from another SRM through the interaction interface and return a response message. When an SRM responds to a query request from another SRM, the SRM needs to interact with the resource monitoring unit to get information about resource utilization of the relevant application servers. The returned response message includes the identifiers, the addresses and the current resource utilization (such as the current response time) of the application servers.

It should be noted that the application servers required by the subscriber service might not be in the management precinct of the current SRM but in the management precinct of another SRM; therefore, interactive communication among SRMs is needed in order to achieve end-to-end QoS guarantee.

4) The service processing unit is a master control module of the SRM, and performs specific subscriber service processing. According to application server types required by the subscriber service which are carried in the service request sent from the service interface unit and application server types monitored by the current SRM, the service processing unit queries the resource interaction unit and/or resource monitoring unit respectively.

According to the current policy delivered from the policy management unit, the current information about resource utilization of each application server and QoS parameters required by the subscriber service returned from the resource interaction unit and/or resource monitoring unit, the service processing unit generates a specific service processing plan, and delivers the processing plan to the application server that has sent the service request through the service interface unit. The specific processing plan may be denial of the service request, or may be a specific list of application servers that meet the requirement of the service request and addresses of the application servers.

5) The policy management unit provides a specific control policy for the subscriber service and the corresponding algorithm, and delivers the control policy and the corresponding algorithm to the service processing unit. The specific control policy includes but is not limited to:

1. Choosing an application server with the shortest response time currently under the condition that QoS requirement of the subscriber service is met.

2. Choosing application servers with the smallest load ratio currently under the condition that QoS requirement of the subscriber service is met.

3. Choosing appropriate application servers randomly under the condition that QoS requirement of the subscriber service is met.

4. Choosing application servers with parameter values closest to the values of the QoS parameters of the subscriber service under the condition that QoS requirement of the subscriber service is met.

Base on the above apparatus, a procedure of a method according to various embodiments of the present disclosure includes the following blocks:

Block 1: an application server sends a service request for a subscriber service to an SRM which the application server belongs to through the service interface unit of the SRM. The service request carries information about application server types and QoS parameters required by the subscriber service.

Block 2: the service processing unit of the SRM obtains information about application server types and QoS parameters required by the subscriber service from the received service request.

When the application server types required by the subscriber service are all stored in the resource monitoring unit of the SRM, the service processing unit of the SRM sends a query request to the resource monitoring unit of the SRM to obtain resource utilization of the corresponding application servers. The resource monitoring unit obtains information about the addresses and the current resource utilization of the application servers required by the subscriber service according to the query request sent by the service processing unit, and returns the obtained information about the addresses and the current resource utilization of the application servers to the service processing unit.

When the application server types required by the subscriber service are all in the management precinct of other SRMs, the service processing unit of the SRM sends a query request to the resource interaction unit. The resource interaction unit interacts with the other SRMs, transfers the received query request to the other SRMs, and receives information about the addresses and the current resource utilization of the application servers required by the subscriber service returned by the other SRMs and returns the received information about the addresses and the current resource utilization of the application servers to the service processing unit.

When application server types required by the subscriber service are both in the resource monitoring unit of the SRM and in the management precinct of other SRMs, the service processing unit of the SRM sends a query request to both the resource interaction unit and the resource monitoring unit, and receives information about the addresses and the current resource utilization of the application servers required by the subscriber service returned by the resource interaction unit and resource monitoring unit.

Block 3: According to the information about the addresses and the current resource utilization of the application servers required by the subscriber service returned by the resource interaction unit and/or resource monitoring unit, the current control policy delivered from the policy management unit and the QoS parameters required by the subscriber service, the service processing unit generates a specific service processing plan and delivers the processing plan to the application server which has sent the service request through the service interface unit. If the QoS requirement of the subscriber service can not be met, then the specific service processing plan is denial of the service request of the subscriber service. Otherwise, the specific service processing plan includes a list of application servers which provide service for the subscriber service and addresses of the application servers.

The resource monitoring unit of the SRM modifies the relevant resource parameters of the relevant application servers according to the obtained information about the addresses and the current resources of the application servers.

One scenario of the method according to the embodiment of the present disclosure is as follows:

A subscriber chooses a movie which he wants to watch by sending a short message. In this scenario, a short message server processes the message sent by the subscriber and transfers the relevant information to a movie server. The movie server plays the corresponding movie to the subscriber according to the received information.

There are a short message server 1, a short message server 2 and a short message server 3. The three short message servers are all managed by SRM1 and the current resource utilization of each short message server is as follows: server 1:delay=0.5 ms, load ratio=50%; server 2:delay=1 ms, load ratio=30%; server 3:delay=2 ms, load ratio=70%.

There are a movie server 1 and a movie server 2. The two movie servers are both managed by SRM2 and the current resource utilization of each movie server is as follows: movie server 1:delay=3 ms, load ratio=50%, bandwidth=20K; movie server 2:delay=4 ms, load ratio=40%, bandwidth=40K. The current control policy is choosing application servers with the shortest response time under the condition that QoS requirement of the subscriber service is met.

SRM1 receives the service request sent by the subscriber by means of short message. The service request carries information about the requirement of subscriber service on short message server and movie server and the QoS requirement of the subscriber service. Specifically, the information is as follows: the total delay <5.5 ms and bandwidth of movie server >30K. SRM1 queries the resource monitoring unit according to the QoS requirement of the subscriber service, and the resource monitoring unit returns the current resource utilization of short message server 1 and short message server 2. Also, SRM1 sends a query request carrying the information about the QoS requirement of the subscriber service to SRM2, and SRM2 returns information about the current resource utilization of movie server 2 which meets the QoS requirement of the subscriber service (bandwidth>30K).

According to the information returned from short message server 1, short message server 2, and SRM2, SRM1 determines the combinations of Short message server and Movie Server which meet the QoS requirement of the subscriber service currently:

Short message server 1, Movie server 2

Short message server 2, Movie server 2

Then, according to the current control policy, namely choosing application servers with the shortest response time, SRM1 chooses short message server 1 and movie Server 2 to provide service for the subscriber service, and returns the relevant information about short message server 1 and movie server 2 to the subscriber who has sent the request.

What has been described above is only preferred embodiments of the present disclosure, but the scope of the present disclosure is not limited thereto. Any variation or substitution easily conceivable by those skilled in the art within the technical scope disclosed in the present disclosure should be encompassed in the scope of the present disclosure. Therefore, the scope of the present disclosure should be defined by the claims.

What is claimed is:

1. An apparatus comprising a Service Resource Monitor/Manager (SRM), the SRM comprising a resource management unit and a service processing unit, wherein
the resource management unit is adapted to monitor and manage resource utilization of application servers within a service network, and return information about resource utilization of corresponding application servers according to a query request sent by the service processing unit;
the service processing unit is adapted to send the query request to the resource management unit according to information, carried in a received service request, about QoS requirement required by the subscriber service, receive the information about resource utilization of the corresponding application servers returned by the resource management unit, generate a processing plan for the subscriber service according to the information about QoS requirement and the information about resource utilization, and deliver the specific processing plan to a sender of the service request.

2. The apparatus as claimed in claim 1, wherein the SRM further comprises:
a service interface unit adapted to receive the service request of the subscriber service sent through an application server, deliver the received service request to the service processing unit, and deliver the processing plan generated for the subscriber service by the service processing unit to the application server which has sent the service request.

3. The apparatus as claimed in claim 1, wherein the SRM further comprises:
a policy management unit adapted to provide a specific control policy for the subscriber service and deliver the control policy to the service processing unit,
the service processing unit is further adapted to generate a processing plan for the subscriber service according to the control policy, the information about QoS requirement, and the information about resource utilization.

4. The apparatus as claimed in claim 1, wherein the resource management unit comprises:
a resource monitoring unit adapted to monitor resource utilization of managed application servers by initiative querying or by initiative reporting of application server, and modify information about resource parameters of relevant application servers according to the processing plan generated for the subscriber service by the service processing unit.

5. The apparatus as claimed in claim 4, wherein the resource management unit further comprises:
a resource interaction unit adapted to send a query request to another SRM and obtain resource utilization of application servers managed by the other SRMs, receive a query request from another SRM and return resource utilization of application servers managed by the SRM to the other SRM sending the query request.

6. A method for providing end-to-end QoS guarantee within a service network, wherein an SRM is configured within the service network, the method comprising:
monitoring and managing, by the SRM, resource utilization of application servers within the service network;
after receiving a service request of a subscriber service, generating, by the SRM, a processing plan for the subscriber service according to the obtained resource utilization of the application servers within the service network, and information, carried in the service request, about QoS requirement required by the subscriber service, and delivering the specific processing plan to a sender of the service request.

7. The method as claimed in claim 6, wherein the method comprises:
receiving, by the SRM, the service request of the subscriber service sent through an application server, the service request carrying information about QoS requirement and application server type required by the subscriber service;
querying, by the SRM, resource utilization of application servers managed by the SRM and/or interacting with another SRM according to the information about QoS requirement required by the subscriber service, and obtaining information about resource utilization of corresponding application servers;
generating, by the SRM, the processing plan for the subscriber service according to the information about QoS requirement required by the subscriber service, the obtained information about resource utilization of corresponding application servers and a preset control policy information, and delivers the processing plan to the sender of the service request.

8. The method as claimed in claim 7, wherein the processing plan comprises denial of the service request of the subscriber service, or a list of application servers which provide service for the subscriber service and addresses of the application servers.

9. The method as claimed in claim 7, wherein the control policy comprises at least one of the following:
choosing application servers with the shortest response time under the condition that the QoS requirement of the subscriber service is met;
choosing application servers with the smallest load ratio under the condition that the QoS requirement of the subscriber service is met;
choosing application servers randomly under the condition that the QoS requirement of the subscriber service is met; and
choosing application servers with parameter values closest to values of QoS parameters required by the subscriber service under the condition that the QoS requirement of the subscriber service is met.

10. The method as claimed in claim 6, wherein the resource utilization of the application servers comprises information about QoS parameters of the application servers, and the information about QoS parameters comprises information about load ratio, response time, bandwidth, code rate and/or display resolution of the application servers.
